(19) United States
(12) Patent Application Publication
(10) Pub. No.: US 2016/0058643 A1
(43) Pub. Date: Mar. 3, 2016

(54) Breathing platform

(71) Applicant: Christopher A. Slotten, Goodyear, AZ (US)

(72) Inventor: Christopher A. Slotten, Goodyear, AZ (US)

(21) Appl. No.: 14/121,166

(22) Filed: May 26, 2015

Related U.S. Application Data
(60) Provisional application No. 61/863,302, filed on Aug. 7, 2013.

(51) Int. Cl. A61G 15/02; A61G 15/12

(52) U.S. Cl. CPC A61G 15/02; A61G 15/12

(57) ABSTRACT

Said invention is an apparatus that sits on the ground and is close to the ground. Users sit on a Seat Pan and lean back on parallel Rails. Said apparatus has a Pivot Point which allows users to rock back and inhale and rock forward and exhale. These simple actions help everyone breathe better. These simple actions reverses belly breathing, reengages diaphragm breathing and builds the core muscles necessary to support diaphragm breathing. Belly breathing is when the belly extends with a deep inhale. Diaphragm breathing is when the chest expands with a deep inhale. Not all belly breathers have COPD, but all COPD patients are belly breathers. Reengaging diaphragm breathing increases airflow thereby reducing symptoms of early COPD. Belly breathers have difficulty exhaling CO₂. CO₂ builds up creating an acidic environment, which is associated with many diseases. The Breathing Rocker helps eliminate CO₂ buildup in the lungs.

### CROSS-REFERENCE TO RELATED APPLICATIONS

Provisional Application Ser. No. 61/863,302, filed Aug. 7, 2013. Information Disclosures begin after Page 24

### STATEMENT REGARDING FEDERALLY SPONSORED RESEARCH OR DEVELOPMENT

Not applicable

### REFERENCE TO SEQUENCE LISTINGS

Not applicable

### BACKGROUND OF THE INVENTION

Field of endeavor: breathing. November, 2008, a car accident followed by a failed medial-branch ablation, T-3, left pain intense enough to stop diaphragm breathing. I became a belly breather. I inhaled with my core stomach muscles into my belly instead of using my diaphragm and inhaling into my chest.

But the belly breathing progression is evil. Core muscles become breathing muscles, belly extends, intestines expand into the increased space, chest begins to collapse, belly extends more, intestines expand more, the space for ‘air’ to be inhaled into remains limited, back problems develop from lack of core muscle support, the elephant sits on your chest, hernias pop out, O₂ is required, COPD and other complications take over.

God and I were motivated by breathing to create a solution for me. I elevated a 1″×8″ on a 2″×4″ padded with a blanket to stretch my ribcage. I was trying to increase the elevation by moving the 2″×4″ when it flopped flat, scared me and I thought, ‘There's something there.’ I screwed the 2″×4″ to the 1″×8″ and began experimenting with padding of wood, fabric, foam and zip ties. It worked for me (and I have used a version of the Platform every day since), but the first version was nonadjustable. It fit me, but not others.

The second version had unlimited adjustments so it could be used by others and adjusted to all body sizes and shapes. There ended up being a relatively narrow range of adjustments required to fit 95% of the people.

The third version (Charlie) was designed and built around Medline Industries production parameters. Medline was interested in producing the product in June, 2013 so I filed a provisional patent (61/863,302 Aug. 7, 2013). Sometime in between my contact with Medline Industries and the finalization of the Provisional Patent, the impact of the Affordable Care Act, a 40% tax on medical equipment and the new approval requirements caused Medline to recommend creating a ‘sports equipment’ variation. What was not public at that time was Medline planning to move to the Netherlands in February, 2014.

In the provisional patent, I wrote about simpler ways to construct the invention. Ways to strip the ‘Couch Platform’ to its critical parts of 2 rails, strip the side rails from the seat platform leaving just the seat platform and using a single pivot point instead of two feet. I used that basis to created a ‘one-off’ version 4 for a sports club enthusiast that verified the need for limited adjustments. I used the Series 2 platform to get the correct dimensions for her body and her specific needs. It worked great.

I built 3 versions 5's that just had the laminated plywood base without side rails or padding. I used the rails independent from/taken off of the ‘Couch Platform’. I used a single pivot point to replace the two feet as I had discussed in the Provisional Patent.

Feedback from the user of the Version 4 was that a Pivot Point 2″ higher or taller made the backwards tilt greater and platform more effective. Increasing the height of the Pivot Point would make the forward slope greater creating the need for the Front Support to be elevated 2″ to keep user from sliding off.

Version 6 was similar to Version 5 but incorporating the higher front support and a adjustable height pivot point. The higher setting on the Pivot Point was liked by 100% of the users.

Two of the three Version 6's built were cannibalized to create the production tooling for version 7. Version 7 has the new front support height and a fixed height pivot point at the higher height. 24 Version 7s were created for me by Arizona Prison Industries in May of 2014 for testing by medical professionals. That version/evolution is the invention under consideration for a Utility Patent.

### BRIEF SUMMARY OF THE INVENTION

A quick search of the US Patent Office patents and applications confirms that this is the first invention designed, engineered, tested and built to reverse belly breathing, reengage diaphragm breathing and build the core muscles necessary to support diaphragm breathing.

The Breathing Rocker is a very simple, effective tool that when used regularly improves breathing.

The Breathing Rocker's simple rocking action disassociates the core muscles from breathing and engages the core muscles in association to breathing.

The Breathing Rocker's curved Rails rock back far enough that the ribcage follows gravity backwards, away from the waist, then forward, towards the waist with the forward rock. The back and forth rocking and back and forth movement of the ribcage replicates diaphragm breathing helping to reengage diaphragm breathing.

The Breathing Rocker is easy to use because if it's not simple, it will not be used. The Breathing Rocker is also simple because it must be inexpensive to manufacture.

COPD and many other medical challenges associated with belly breathing have a socioeconomic component. COPD tends to be a poor-man's disease, just as smoking is significantly more prevalent among the poor.

### Problems Associated With Belly Breathing

Not every belly breather has COPD, but every COPD patient is a belly breather.

Belly Breathers have problems exhaling the CO₂ from their lungs.

CO₂ buildup causes acid buildup in the lungs and in the body.

The medical ramifications of an acidic body caused by belly breathing are beyond the scope of this document.

Most, maybe all, cancer patients are belly breathers.

Most, maybe all, of conjunctive heart patients are belly breathers.

That is why this invention is so important. It is a simple ‘tool’ to be used in conjunction with training to help users breathe better. Much more information is in the section on USING THE INVENTION.

### BRIEF DESCRIPTION OF THE SEVERAL VIEWS OF THE DRAWING

The Breathing Rocker has 5 major elements and connecting hardware. The connecting hardware may not even be needed if the Breathing Rocker is manufactured in one piece.

Drawing Sheets 1/1 and 1/2

Drawing 1,

FIG. 1—the seat pan,

FIG. 2—the two rails,

FIG. 3—the pivot point,

FIG. 4—the front support,

FIG. 5—the pivot point adjustment holes,

FIG. 6—the rail mounting holes.

Drawings 2 and 3 show different perspectives of the same elements.

Not shown are the two mounting holes for the front support. The two mounting holes for the front support have the same spacing as the pivot point so the pivot point can be replaced with the front support for use on massage tables or beds or by users who want to begin with less tilt.

Not shown is a critical element, the Headrest. At the time the illustrations were made, the most common headrest was rolled up hand towels which would never be part of the Utility Patent. Headrest evolutions are discussed in the DETAILED DESCRIPTION OF THE INVENTION.

### DETAILED DESCRIPTION OF THE INVENTION

The Invention for consideration for this patent, the Breathing Rocker, is a Series 7 prototype. The Provisional Patent was on Series 3. They both have the most critical parts and exact same functions. Series 3 and Series 7, the Breathing Rocker, have approximately the same dimensions because they were both constructed from ‘Russian’ aka. ‘Baltic Birch’ plywood. The plywood sheets were 5′×5′ or 60″×60″. That made 15″, 20″ and 30″ dimensions optimum.

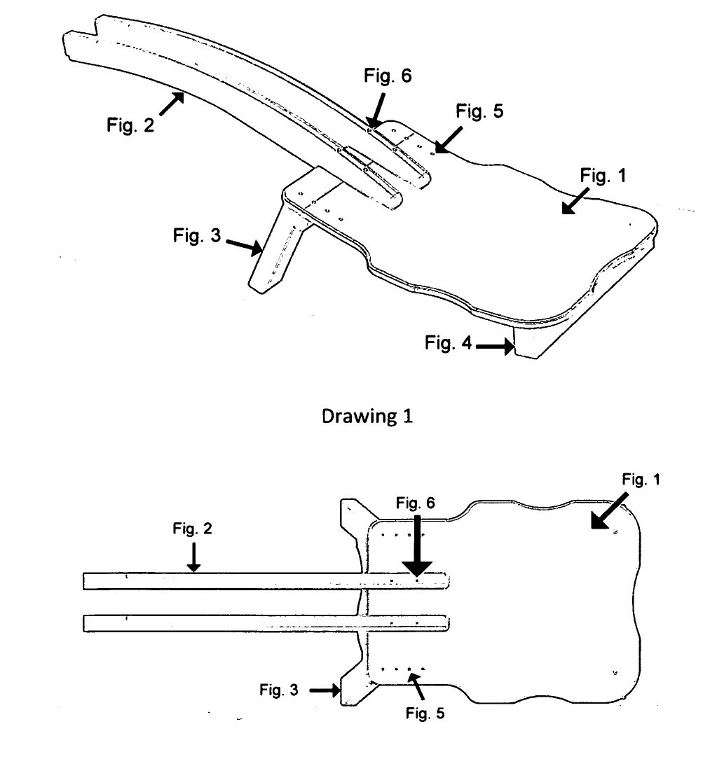

### Seat Pan (FIG. 1)

The Breathing Rocker simplified Seat Pan is an option discussed in the Provisional

Patent. The Breathing Rocker seat pan was formed on the same jig that was used for the Series 3. Both ‘Seat Pans’ are constructed of 4 layers of ⅛ inch plywood bent, glued and clamped to the same jig. For both, the ⅛ inch plywood is cut to 15 inches by 20 inches before it is formed. The Breathing Rocker Seat Pan (FIG. 1) finished dimensions are 15 inches wide, 19½ inches long and ½ inches thick. The seat pan was cut to its existing shape as a design element.

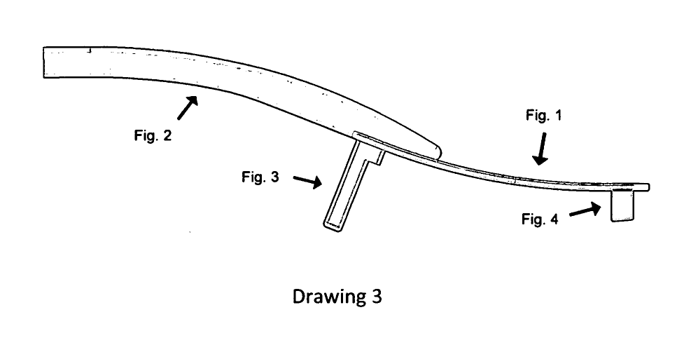

For both Series, holes are drilled in the Seat Pan using a hole jig. The Series 3 had holes for the padding assemblies. The Breathing Rocker has 8) 5/16 inch holes 9½ inches apart for the adjustable Pivot Point (FIG. 2) There are two rows of 4 parallel holes at the top of the Seat Pan to provide pivot point adjustments. The holes for mounting the Rails (FIG. 6) are 5/16 inches. There are 2 for each rail. The first two holes are 1 inch from the top edge. The second set of holes is 3 inches from the top edge. The holes are 1½ inches out from the center line keeping the Rails 3 inches apart.

The Breathing Rocker Seat Pan (FIG. 1) was then coated with ‘truck bed liner’ to provide a durable finish.

This Seat Pan would be easier to mass produce in plastic, whether that is steel tube frame with a vacuum formed plastic cover, injectable plastic part or rotational molding plastic part. It could even be steel much like a snow shovel.

### Rails (FIG. 2)

The ‘rails’ on Series 3 and Breathing Rocker are the same size, curve and padding. The curve radius is about 80 inches for both.

With the Breathing Rocker, the ‘Couch Platform’ discussed in the Provisional Patent is replaced with independent, simpler Rails (FIG. 2) as discussed in the Provisional Patent. The Breathing Rocker rails needed to be stronger to compensate for the lack of support from the removable ‘Couch Platform’.

Breathing Rocker rails were made removable for ease of shipping, but removable rails is not necessary and has no impact of the function.

The Breathing Rocker Rails (FIG. 2) are 2½ inches tall, 1½ inches thick and 27 inches long. They are constructed of ¾ inch plywood, with ¼ inch plywood laminated to both sides. The parts were rough cut with a jig saw and final shaping done with a router and template. The ¼ inch was left slightly smaller on the bottom side to leave room for stapling the foam.

After gluing, the rails are drilled for two threaded inserts each and ¼×20 inserts are screwed in for attachment to the Seat Pan. If it is decided that it is not necessary to have removable rails, this step could be replaced with screws and glue.

The rails were routed with a ⅝ inch router bit on the top edges. All other edges were routed with a ¼ inch bit.

The rails have ¼ inch memory foam stapled around the top edge. Then a ‘sport's equipment’ washable fabric incorporating an additional ¼ inch memory foam sleeve is slid over each rail and attached with a single staple.

There are still options being considered for the Rails. One idea is a single piece that has 200 a channel in the middle to prevent contact with the spine. A single ‘sleeve’ pad may reduce costs. Steel tubes with a single pad slid over the two rails may reduce costs. And, of course, plastics of all kinds are being evaluated. The function is critical. The construction process is not.

### Pivot Point (FIG. 3)

The Breathing Rocker Pivot Point (FIG. 3) is a single piece instead of the two feet used in the Provisional patent. This option was discussed in the Provisional Patent and provides a much simpler method of providing an adjustable pivot point.

The Pivot Point is 6 inches high and 14 inches wide. It is constructed of two pieces of ¾ inch plywood laminated together.

A top section of ¾″ plywood was added to add additional strength when rocking and as a means to hide ¼ inch carriage bolts that would extend out the top and not come loose. The carriage bolts provide a means of attachment to the Seat Pan that is simple to adjust. The bottom of the Pivot Point was cut out to yield two ‘feet’. The cut out for the Breathing Rocker was made to look similar to the side view of the Breathing Rocker. Then all edges, except the top, were routed with a ⅝ inch round-over bit. This yields a round edge for the Pivot Point bottom where it contacts the ground.

The Pivot Point was then coated in truck-bed liner for a durable finish. The truck-liner coating also provides a small about of resistance towards slipping when users get on the Breathing Rocker, when rocking back and forth and limits the amount the Breathing Rocker ‘kicks’ out when the user is rolling off. All were problems discovered in the Series 5 platform. If the Breathing Rocker was built in wood again, the carriage bolts might be replaced with threaded inserts and short ¼ inch threaded stock.

Continuing considerations are ongoing for mass production. The Pivot Point could be a single piece of metal tubing bent to be two feet and contact the Seat Pan. The Pivot Point could be of plastic. The adjustment mechanism is an area still under development.

### Front Support (FIG. 4)

The Breathing Rocker Front Support (FIG. 4) was not part of the Series 3 in the Provisional Patent because the Series 3 rails served as the front support. When the design was simplified, the need for a front support to limit forward tilt when sitting became necessary.

When Series 5, with the adjustable height pivot point was tested, it became obvious that the increased height of the pivot point required an increased height Front Support.

The Breathing Rocker Front Support (FIG. 4) is 2¼ inches high, 14 inches long and 1½ inches thick The Front Support is constructed of two layers of ¾ inch plywood glued together. The bottom edges are radiused with a ⅝ inch round-over bit and the side edges have a ¼ inch radius. The holes and threaded inserts for mounting the Front Support to the Seat Pan are centered and 14½ inches apart, the same spacing as on the Pivot Point. This allows the Pivot Point to be replaced with the Front Support if a lower height with less motion is desired or the Rocking Platform is going to be used on a massage table or bed.

Although the Breathing Rocker Front Support has a solid bottom, future versions will be cutout in the middle to produce two ‘feet’ as in the Pivot Point. This will reduce weight and make it more stable when it is used as a Pivot Point. Also, although this is the simplest element, considerations for mass production are still being considered. The Front Pivot point could be part of the Seat Pan. Permanently attached would eliminate the uses as a Pivot Point, but manufacturing costs may make that option not worth the additional cost.

### Pivot Point Adjustment Holes (FIG. 5)

The Breathing Rocker's Pivot Point adjustment holes (FIG. 5) were discussed in paragraph [0053]. They are brought to discussion again to reinforce the work being done to simplify the Pivot Point adjustment.

Under consideration are adjustments that would loosen when the user is off and lock when in use.

Different means of threaded shafts and knobs might be tested.

Adjusting the Rails could be a Pivot Point adjustment by shifting the center of gravity.

A simple Pivot Point mounting that would allow the Pivot Point to rotate to different settings that would shift the Pivot Point.

A rotating Pivot Point could be controlled by a side knob that locked by pulling in or out. It could be combined with a ‘in use’ locking feature.

What is important is that the function remains the same, adjustment is easy and minimized manufacturing costs.

### Rail Mounting Holes (FIG. 6)

The Rail Mounting Holes (FIG. 6) were discussed in Paragraph [0038]. They are brought to discussion again because they are not needed if the Breathing Rocker is manufactured in one piece. Again, what is important is that the function remains the same and minimized manufacturing costs.

Head Rest (Not shown)

The Headrest is critical element because most users have had bad, head forward of balanced, posture long enough that their head doesn't easily move back to its natural balanced position. This causes the muscles in the neck and shoulders to support the mass of the head. Those muscles were never intended to support the mass and become over worked; tight, tense, spasm and resist allowing the head back to its natural position. Texting creates a new posture that compounds this problem.

The easiest way to see a naturally balanced head is to watch a child as they learn to walk. The way their head leans is the way they walk because the mass of the head is proportionally greater than later in life.

The critical element headrest is not shown because it is still in final development.

Many of the 24 series 7 prototypes used rolled up hand towels for headrests. They worked, but were primitive.

Small balls of all sizes, shapes and densities are being tested. They need to be soft enough to be comfortable and cleanable with standard hospital disinfecting solutions.

The current headrest under testing is a pair of 2¼ inch self-skinning balls mounted to the top of a ‘T’ apparatus where the leg of the ‘T’ goes in between the two rails. The final iteration will be determined by the manufacturing technology used.

### Using the Invention

The short instructions are, ‘Sit down. Lean Back. Rock back and inhale. Rock forward and exhale.’

It is that simple. But more details make it easier and more effective.

First, the Breathing Rocker is on the ground. The Seat Pan is supported by the Pivot

Point and Front Support putting the Seat Pan only 3 inches off the ground.

Before getting down, the user needs to consider arranging the support the user might need to help them get up. Many potential users have challenges getting up, so placing a stable chair nearby or placing the Breathing Rocker near a stable chair, table or couch is the first consideration. The Breathing Rocker on end is a good support, but not in the beginning because it is not a solid support, more like a cane, than a solid chair.

Before getting on the Breathing Rocker, the user needs to know how easy it is to get off of the Breathing Rocker. Most users haven't done a sit-up in years. The Breathing Rocker is close to the ground. The user just rolls off and onto their hands and knees. Then the user can get up slowly when they feel ready to stand up.

The next step is to adjust the Pivot Point to a starting point. Taller users, over 6 foot 2 inches, will want to adjust the Pivot Point to the first or second hole from the top edge. The second hole is the starting point for the majority of the users. Smaller users, under 5 foot 2 inches, will want to adjust the Pivot Point to the third fourth hole to begin. The fourth hole, farthest from the top, also creates the greatest demand on core muscles. The first hole, nearest the top, also creates the greatest demand on the thigh muscles.

Adjust the head rest (not shown) towards the top of the rails so that it is out of the way when the user leans back. They will adjust it for comfort after reclining (Paragraph [0082]).

Sit down sounds easy.

But because the Breathing Rocker is on the ground, and the Seat Pan is only a few inches off the ground and many users have not sat on the ground for decades, it may take some planning. The easy way to sit on the Breathing Rocker is to get on your knees in front of and next to, in front of one of the front corners, and roll/flop onto the Seat Pan.

Once sitting on the Seat Pan, the user positions their bottom close to the Rails and approximately centered. Exact positioning doesn't matter since once you lean back the Rails will position the user's bottom to the correct, comfortable position.

Lean back for most users will be more like ‘flop back’ because most users do not have 315 the core muscles necessary to control a smooth reclining motion. If the user uses their arms for support while they are leaning back, it is a smoother action. Once the user is being supported by the Rails, they will feel how to make slight movements to adjust their bottom to be centered and against the Rails.

The user adjusts the headrest for comfort either under the user's neck or head.

Relax. This is an important step. The Breathing Rocker begins to work immediately, without any movement. The Rails are designed to allow the user's shoulders to drop back. This opens the user's chest allowing the chest cavity to expand. Immediately breathing is easier, even for belly breathers. The curved Rails create more room in the belly for belly breathers to breathe into. This instant relief is amazing to all belly breathing users and important to motivate them to use the Rocking Platform regularly.

The Rails align the spine and massages the central back muscles.

The Relax step (Paragraph [0083]) also is the time for the user to slowly move their arms around and discover the effect of their arms on the balance of the Breathing Rocker.

Putting the arms over the head may cause an unintended tilt back, which can be disconcerting if not discovered intentionally in the beginning.

Keeping the arms over the head also makes it harder to rock forward. It requires more core muscles which is good only when intentionally building core muscles.

After the user understands the effect of their arms, it is time to push down on the ground with their feet and rock halfway back. Stopping in the middle is an important step for the user to become accustomed to the new sensation.

The Breathing Rocker rocks back farther than expected and going all the way back in one step can cause concern as to ‘When is it going to stop?’. If the user has gained confidence with the effect of their arm movements, this level of concern is much less. If the user pauses halfway, the level of concern is all but eliminated.

While paused halfway back, there is more weight on the Rails and less on the Seat Pan. When paused in the middle, the Breathing Rocker is even more effective at promoting the shoulders to drop back and opening the chest and expanding the chest cavity. Breathing becomes easier for belly breathers because their intestines follow gravity and leave more room for belly breathing.

New diaphragm breathers enjoy the pause in the middle because it opens the chest cavity allowing for more room to breathe into.

Paused halfway back also yields a second opportunity for the user to discover the effect of their arms as they relate to the movement of the Breathing Rocker.

After a few moments paused halfway, the user pushes down more with their feet, or raise their arms over their head, to rock all the way back until the Rails contact the ground.

Rocked all the way back is the second opportunity to pause. The Breathing Rocker inverts to a compromise of far enough to help open the chest and stretch the spine yet not far enough to cause concern or stress the lower back.

The Breathing Rocker rocks back far enough to allow the spine to elongate.

Removing the Headrest as soon comfortable increases the effective amount of inversion.

The final angle of inversion is approximately 68 degrees past vertical at the very end of the Rails.

With the Breathing Rocker paused all the way back, the user is encouraged to experiment with the effect of their arms.

The spinal stretch increases when the arms are put over the head.

The chest cavity opens more when the arms are put over the head.

More core muscles are required to rock forward when the arms are over the head.

When the arms are placed at the waist, sometimes the Breathing Rocker rocks forward without any need for core muscles.

With the arms placed at the waist, there is less core muscle effort to rock forward.

After experimenting with the effects of the arms, it is time for the user to rock forward either using their arms, core muscles or a combination of both.

NOW it becomes easy to rock back and inhale and rock forward to exhale. It is now that the user is encouraged to suck their stomachs in while rocking back and forth. Belly breathers tend to push their stomachs out for support.

An occasional pause inverted is always beneficial.

For belly breathers, it is important to do fewer repetitions, not more. If a belly breather does too many repetitions and causes their core muscles to become tired and sore, it becomes very disconcerting when using the core muscles to breath. By the end of the day, advanced belly breathers have an elephant sitting on their chest. Add to the elephant sore core muscles, which are breathing muscles for belly breathers, and it can be frightening.

A quick note on the belly breathing progression is appropriate at this point.

Breathing is naturally CO₂ regulated, not O₂ regulated. People inhale because of a buildup of CO₂, not because of a lack of O₂.

First the belly extends because the core stomach support muscles become breathing muscles. The intestines expand into the increased cavity. The chest begins to collapse. The shoulders begin to roll forward. The belly extends more. The intestines expand more so the available space to breathe into actually begins to decrease. Airflow, the volume of air entering and exiting the lungs, decreases. CO₂ is not exhaled effectively. The CO₂ builds up creating an acidic environment. The body adjusts to the higher levels of the CO₂/acidic environment. The acidic environment is associated with many medical challenges. Breathing stops being CO₂ regulated and becomes O₂ regulated. (The Breathing Rocker is not recommended for use beyond this point.)

The chest collapses more and begins to reduce the volume of space for the heart. Back problems develop. Hernias begin to pop out between the stretched core muscles. O₂ is administered in short bursts, which shortens the breath even more. Acidic CO₂ buildup becomes even worse. Full blown COPD has set in.

When rocking back and forth on the Breathing Rocker, the rib cage follows gravity and replicates diaphragm breathing. In a matter of a day to a few weeks, diaphragm breathing is reengaged while using the Breathing Rocker. Diaphragm breathing while not using the Breathing Rocker takes longer.

Continue use of the Breathing Rocker develops the core muscles necessary to support diaphragm breathing off the Breathing Rocker. The first diaphragm breathing away from the Breathing Rocker is either while lying down or standing up.

Diaphragm breathing while walking is a quick evolution with a warning.

Belly breathers becoming new diaphragm breathers are cautioned to stay close to home when they start walking. Walk back and forth in front of your house. Do not get too far from home until diaphragm breathing is solid. Diaphragm breathing is elusive in the beginning. Walking away from your house while diaphragm breathing is easy and fun. But in the beginning, diaphragm breathing will go away. Belly breathing comes back. Walking back as a belly breather can be a very long, frightening walk.

Diaphragm breathing while sleeping can be sporadic.

The last, hardest, diaphragm breathing to master is while sitting.

1. The invention claimed is a rocking apparatus comprising:
a place for the user to sit (FIG. 1);
a support for the user to lean back against or to lay down upon (FIG. 2);
a pivot point which said apparatus can rock back and forth upon (FIG. 3);
a headrest (Not shown);
and a front support (FIG. 4);
where on said apparatus the user can sit down on the seat pan, lean back on the back support and rock back and forth on the pivot point, inhaling when they rock back and exhaling when they rock forward.

2. In reference to said apparatus recited in claim (1), the user leans back on supports that are narrower than the shoulder blades and provide support on both sides of the spine but with no or limited contact with the spine.

3. In reference to said apparatus recited in claims (1 & 2), the back support is narrow enough to allow the shoulder blades to drop down causing the chest to open up meaning the distance between the shoulders increases thereby increasing the size of the chest cavity or ribcage and creating more room for the user to breathe into.

4. In reference to said apparatus recited in claims (1, 2 & 3), the back support has a large radius arch, at approximately an 80 inch radius, increasing the distance between the collar bones and the waist thereby increasing the amount of space in the chest cavity thereby creating more room for the user to breathe into.

5. Said apparatus recited in claim (1) has a critical adjustable Pivot Point (FIG. 3) or fulcrum which said apparatus rocks back and forth on.

6. The said Pivot Point in claim (5) adjusts for different size users meaning for taller and shorter users.

7. The said Pivot Point in claims (5 & 6) can also be adjusted to focus on increasing core muscles effort or adjusted to increasing thigh muscle effort to activate the rocking process.

8. In reference to said apparatus recited in claim (1), the said apparatus rocks back far enough to go slightly inverted which causes the ribcage to follow gravity, to move away from the waist which increases the volume inside the ribcage or chest cavity for the user to breathe into;
and when said apparatus rocks forward the ribcage returns to its original position closer to the waist.

9. In reference to said apparatus recited in claim (1), there is a movable and removable headrest to support the user's head either under the head or neck;
once the user's back and neck has loosened enough to remove the headrest, removal effectively increases the degree of inversion when said apparatus is in the ‘rocked back’ position and allows for more stretching of the back and chest which increases the space between the shoulders and the space between the collar bones and the waist thereby increasing the effective volume of the chest cavity allowing for more volume for the user to breathe into.

10. Wherein said rocking apparatus is used properly; said devise and method of using said 490 devise makes breathing easier for almost everyone.

11. In reference to the use of said apparatus recited claims (1, 2, 3, 4, 8 & 10), belly breathers instantly have breathing relief, even while still being belly breathers (Belly breathers are defined as people who's belly expands when they inhale deeply).

12. In reference to the use of said apparatus recited in claims (1, 8 & 10), belly breathers can reduce acid causing CO₂ in the lungs because the platform rocks inverted enough to allow CO₂, which is heavier than air, to be exhaled. (We make no claim to being able to reduce blood CO₂ levels at this time recognizing the difference between CO₂ in the lungs and CO₂ in the blood.)

13. In reference to the use of said apparatus recited in claims (1, 8 & 10), when the user rocks back and forth, their core muscles work properly as support muscles and eventually stop being used improperly as breathing muscles.

14. In reference to the use of said apparatus recited in claims (1, 8, 10 & 13), the said invention aids in the reversal of belling breathing because it reengages core muscles for movement functions instead of breathing muscles.

15. In reference to the use of said apparatus recited in claims (1, 3, 4, 8, 9, 10, 13 & 14) said apparatus and proper use of said apparatus aids in the reengagement of diaphragm breathing because;
in claim (1) the basic rocking action is similar to diaphragm breathing in that the chest goes up with an inhale and down with an exhale,
in claim (3) the chest cavity increases because the back support allows for the shoulders and shoulder blades to drop back, opening the chest and allowing for more room to breathe into,
in claim (4) the large radius arch of the back support also helps open the chest cavity to allow for more room to inhale into,
in claim (8) the inversion of said apparatus encourages the ribcage to follow gravity, moving up and down with inhaling and exhaling, replicating diaphragm breathing,
in claim (9) the removal of the headrest increases the effective inverted slope,
In claim (10) the proper use of said apparatus,
in claim (13) the core muscles begin to work as support muscles which are required to support diaphragm breathing,
and in claim (14) the core muscles stop being belly breathing muscles and become diaphragm breathing support muscles.

16. In reference to the use of said apparatus recited in claims (1, 10, 13 & 14), the rocking platform builds the core muscles necessary to support diaphragm breathing for normal daily activities.

17. In reference to the use of said apparatus recited in claims (1, 10, 15 & 16) the rocking platform by reengaging diaphragm breathing increases the volume of air entering and exiting the lungs because diaphragm breathing creates more airflow than belly breathing.

18. In reference to the use of said apparatus recited in claims (1, 10, 15, 16 & 17), the said invention reverses some of the symptoms of early COPD (The elephant sitting on your chest.) and makes it possible to live a better life.

19. In reference to the use of said apparatus recited in claims (1, 10, 15, 16 & 17), this said apparatus may stop the COPD progression.
